(19) United States
(12) Patent Application Publication
(10) Pub. No.: US 2014/0275348 A1
(43) Pub. Date: Sep. 18, 2014

(54) METHOD OF RECOVERING INORGANIC PIGMENT

(71) Applicant: PPG INDUSTRIES OHIO, INC., Cleveland, OH (US)

(72) Inventors: Jane Valenta, Pittsburgh, PA (US); Linda Anderson, Allison Park, PA (US); David Asay, Sarver, PA (US); John Donnelly, Monroeville, PA (US); Michael A. Mayo, Pittsburgh, PA (US); Gregory J. McCollum, Gibsonia, PA (US); Michael Zalich, Pillsburgh, PA (US); Kristi Kauffman, Pittsburgh, PA (US); Roxalana L. Martin, Pittsburgh, PA (US); Michael J. Pawlik, Glenshaw, PA (US); Stuart D. Hellring, Pittsburgh, PA (US); Ruby Chakraborty, Allison Park, PA (US)

(73) Assignee: PPG Industries Ohio, Inc., Cleveland, OH (US)

(21) Appl. No.: 13/803,229

(22) Filed: Mar. 14, 2013

(51) Int. Cl. C08K 3/22; C22B 34/12

(52) U.S. Cl. CPC C08K 3/22; C22B 34/12
USPC 524/1; 423/1; 423/69; 423/610

(57) ABSTRACT

Disclosed is a method of recovering inorganic pigment such as TiO₂ from a coating composition that includes liquid, an organic component, and an inorganic component. The coating composition is thermally treated to remove at least a portion of the organic component and yield an inorganic pigment composition having a higher concentration of the inorganic pigment (TiO₂) than in the original coating composition.

### FIELD OF THE INVENTION

This invention relates to methods of recovering inorganic pigment from coating compositions. In particular, the invention relates to recovering titanium dioxide (TiO₂) from recycled consumer paint.

### BACKGROUND OF THE INVENTION

Scattering pigments such as titanium dioxide are commonly used in coating compositions to achieve opacity in both aqueous and non-aqueous systems. An increase in the cost of producing titanium dioxide has driven efforts to minimize the amount of titanium dioxide used in coating compositions. In addition, alternative routes for obtaining titanium dioxide have been sought.

In the paint industry, it is estimated that nearly seven hundred million gallons of latex paint are sold annually in the United States. It is also estimated that approximately 10% of that paint is unused and is disposed of by the consumer. Within each gallon of paint there is typically about one pound of titanium dioxide. As such, approximately 70 million pounds of titanium dioxide goes unused annually from latex paint purchased in the United States. While some programs for distribution of unused paint have been established in certain markets within the United States, much of the unused paint is disposed of, including the titanium dioxide therein.

### SUMMARY OF THE INVENTION

The present invention includes a method of recovering inorganic pigment from a coating composition, where the coating composition includes a liquid, an organic component and an inorganic component. The method includes thermally treating the coating composition to remove at least a portion of the organic component, thereby yielding an inorganic pigment composition that has a higher concentration of the inorganic pigment than in the coating composition. Also included in the present invention is a method of reusing TiO₂ from unused paint samples that include TiO₂. The method includes removing liquid from a composite of unused paint samples to yield a composite paint concentrate that includes an organic component and an inorganic component, the inorganic component containing TiO₂. The composite paint concentrate is thermally treated to remove at least a portion of the organic component, thereby yielding an inorganic composite having a higher concentration of TiO₂ than in the composite of unused paint samples. Thereafter, the inorganic composite is incorporated into a new paint composition.

### DETAILED DESCRIPTION OF THE INVENTION

For purposes of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

In one embodiment of the present invention, inorganic pigment from a coating composition is recovered by thermally treating the coating composition. As used herein, a coating composition may refer to a conventional consumer paint containing an inorganic pigment, such as a latex paint (an aqueous system) containing TiO₂. However, the present invention is not limited to consumer paint and may be used with coating compositions provided in an aqueous or non-aqueous solvent system. Such coating compositions typically include a liquid, an organic component and an inorganic component. In one embodiment, the liquid may predominantly comprise a solvent such as water or an organic solvent, with optional diluents. The organic component may include an organic polymeric resin, such as the organic resin used in paint compositions (e.g. an acrylic resin of a latex paint), organic pigments and/or other organic additives conventionally used in coating compositions. The inorganic component may include inorganic pigments (e.g. TiO₂) and other inorganic additives conventionally used in coating compositions.

An inorganic pigment composition is obtained from a coating composition (such as latex paint) by thermally treating the coating composition to remove at least a portion of the organic component such that the resulting inorganic pigment composition has a higher concentration of the inorganic pigment than was present in the original coating composition. As used herein, the phrases “thermal treatment”, “thermally treating” and the like refer to the time-temperature regime required to remove the organic component from the coating composition without affecting the inorganic component, particularly avoiding undesired reaction of the inorganic pigment. The time-temperature regime may be selected to ensure removal of at least a portion of the organic component yet retain the inorganic component unaffected by the thermal treatment. By way of example, in certain time-temperature regimes, the TiO₂ in a coating composition may react with calcite in the inorganic component to produce calcium titanate, which generally exhibits a yellowish color. Not only is the desired inorganic pigment (TiO₂) in the resulting inorganic pigment composition at least partially consumed, the inorganic pigment composition may exhibit a color that is not acceptable for use.

Thermal treatment may be accomplished via direct or indirect heating such by using an incinerator, hot plate, furnace or the like, provided there is sufficient oxygen present to incinerate or ash the organic component. Other energy sources may be employed to generate heat for thermal treatment, such as microwave energy or other radiation sources. In one embodiment of the invention, thermal treatment includes incinerating the coating composition to a temperature that removes at least a portion of the organic component. In general, ashing a coating composition at a temperature of at least 400° C. leads to thermal decomposition of the organic component. Substantially all of the organic component is removed so that, at most, an incidental amount of organic material remains in the resulting inorganic pigment composition.

While thermal treatment will eliminate the liquid as well as the organic component from the coating composition, in certain embodiments, it may be desirable to concentrate the coating composition by removing at least a portion of the liquid prior to thermal treatment. Concentration of the coating composition removes at least a portion of the liquid, rendering the subsequent thermal treatment more efficient, in that the heat applied in the thermal treatment is primarily directed to removing the organic component. The coating composition may be concentrated prior to thermal treatment to remove the liquid such as via drying, which may be performed in bulk, at ambient or elevated temperatures, using various industrial dyers or ovens. In one embodiment, concentration of the coating composition is accomplished by drying, such as by drum drying. It has been found that some post-consumer paint that is drum dried tends to form rolls of dried paint as the dried paint is removed from or falls away from the drum dryer. These dried paint samples (rolls, sheets, films or the like) are readily handled in subsequent processing steps, including being transferred to an incinerator for the thermal treatment. In another embodiment, the coating composition may be concentrated by removing the liquid by other separation techniques such as centrifugation. The coating composition may be centrifuged to form a supernatant that is discarded and a coating concentrate. The coating concentrate, obtained by drum drying, centrifugation or other suitable separation techniques, may then be thermally treated (e.g. incinerated or ashed) to remove the organic component from the coating concentrate to yield an inorganic pigment composition.

It has been found that upon incineration (with or without an initial concentrating step) of post-consumer paint compositions, the resulting inorganic pigment composition primarily contains TiO₂, as well as other inorganic components which may contain aluminum, calcium, iron, silicon and/or zinc, in elemental or molecular form. While some residual or incidental organic material and/or hydrocarbons may be contained in the inorganic pigment composition, the concentration of inorganic pigment (e.g. TiO₂) in the inorganic pigment composition is greater than in the initial coating composition. For example, a conventional latex paint typically includes 10-12 wt. % TiO₂. Upon thermal treatment of such a latex paint according to the present invention, the resulting inorganic pigment composition may include 20-65 wt. % TiO₂. Depending on the constituents of the initial coating composition, the relative amount of inorganic pigment in the inorganic pigment composition may be as high as 100% inorganic pigment.

In some embodiments, the coating composition may include magnetic materials, such as iron in the form of a chromatic (e.g. ferromagnetic) pigment, such that the resulting inorganic pigment composition includes iron. The inorganic pigment composition containing iron may exhibit a color (e.g. buff or reddish). When the inorganic pigment composition is intended for replacing a white or light colored pigment (e.g. TiO₂), it may be desirable to remove the chromatic pigment either before or after the thermal treatment step.

Removal of a chromatic pigment may be accomplished by acid extraction, magnetic separation, centrifugation or other mechanisms. In acid extraction, the coating composition, coating concentrate, or the inorganic pigment composition is subjected to an acid treatment, such as with a solution of hydrochloric acid. In acid treatment of chromatic pigments, ions responsible for providing color (e.g. iron) are released into solution, which may then be separated from the composition by decanting, filtering or the like. For certain coating compositions, acid treatment may also be beneficial for neutralizing any calcite that may be present or may have formed during the thermal treatment step. It has been found to be beneficial to treat the coating composition, coating concentrate, or the inorganic pigment composition with sufficient acid to both neutralize calcite and extract the chromatic pigment, particularly since acid extraction of a chromatic pigment may be hindered by the presence of calcite. Following acid treatment, the coating composition, coating concentrate, or inorganic pigment composition can be rinsed and/or filtered to reduce the conductivity to a level that is suitable for use in a coating, such as less than 500 microsiemens or less than 100 microsiemens.

By magnetic separation, it is meant that the coating composition, coating concentrate and/or inorganic pigment composition is exposed to a magnet. The iron-containing constituents (including the chromatic pigment) are attracted to the magnet and separated from the composition. In a centrifugation process to remove iron-containing constituents, the coating composition, coating concentrate, or inorganic pigment composition may be centrifuged to provide an iron-containing layer which may then be separated from the remainder of the centrifuged composition.

An inorganic pigment composition rich in TiO₂ (comprising 20-65 wt. % or higher TiO₂) may then be used as an additive to a new coating composition comprising a resinous binder, utilizing the pigment composition containing TiO₂ as a source of TiO₂ either as the sole source of TiO₂ for the new coating composition or as one of multiple sources of TiO₂ in the new coating composition. The inorganic pigment composition can be treated by milling or dispersing in a dispersing medium as is conventional in preparing additions of pigments to coating compositions. Such post-processing of the inorganic pigment composition can enhance the optical properties (including gloss and/or tint strength) of the coating into which it is added. To the extent that the inorganic pigment composition includes other components such as alumina or the like, it will be appreciated that those other components need to be accounted for when formulating a new coating composition.

The present invention further includes a method of reusing TiO₂ from unused paint samples containing TiO₂. Typically, in the retail consumer market, paint is pigmented in a variety of colors, with various organic and/or inorganic pigments, along with TiO₂. Unused paint samples may be combined to provide a composite paint, which is then used as the starting material for producing an inorganic composite as described above. In situations where the paint is pigmented so it exhibits a particular color (e.g. blue, red, brown), it may be beneficial to combine unused paint samples having the same or similar color as a composite of unused paint samples. Subsequent treatment thereof may be adjusted as necessary to account for the organic pigment or inorganic pigment (particularly, iron-containing pigment as described above). The composite of unused paint samples may be concentrated and thermally treated to produce an inorganic composite. The composite of unused paint samples may be treated to remove liquid therefrom to yield a composite paint concentrate that includes an organic component and an inorganic component, which includes TiO₂ Concentration of the composite of unused paint samples to yield a composite paint concentrate can be performed by drying, centrifugation or the like as detailed above regarding producing an inorganic pigment composition from a coating composition. Likewise, the composite paint concentrate is thermally treated to remove at least a portion of the organic component to yield an inorganic composite having a higher concentration of TiO₂ than was present in the composite of unused paint samples. In addition, the unused paint samples or composite paint concentrates can be treated to remove ferromagnetic material or other chromatic materials. The inorganic composite rich in TiO₂, with optional post-processing thereof, may be used as an additive, alone or with TiO₂ from another source, in a new paint composition, taking into account other components in the inorganic composite besides the TiO₂ when formulating a new coating composition.

The following Examples are presented to demonstrate the general principles of the invention. All amounts listed are described in parts by weight, unless otherwise indicated. The invention should not be considered as limited to the specific Examples presented.

### EXAMPLES

### Example 1

### Thermal Treatment

Three samples of unused post-consumer paint were concentrated using a BUFLOVAK® Laboratory Atmospheric drum dryer. The drum dryer was adjusted to a 0.005 mm gap, with drums rotating at 12 rpm at a temperature of approximately 150° C. The liquid paint was applied to the drum dryer, and the concentrated coating composition was collected as sheets in loose or rolled forms. The concentrated coating compositions were then placed in a muffle furnace at 450° C. for sufficient time to remove the volatile and organic components, about 5-7 hours, yielding pigment compositions. The pigment compositions were analyzed for elemental content (% by weight) by inductively coupled plasma analysis as shown in Table 1.

### Example 2

### Acid Treatment

The pigment composition of Example 1C (131 g) was added to a 2-liter round bottom flask, fitted with a glass rod with a Teflon stir blade and a Teflon coated temperature probe. Hydrochloric acid (4N, 636 g) was added dropwise with stirring to minimize foaming. The resulting mixture was heated to 50° C. and stirred for 6 hours. Upon cooling, the mixture was subject to ultrafiltration until the conductivity dropped below 100 microsiemens. The liquid portion was decanted off, and the resulting solid material was dried in an oven at 110° C. overnight. The resulting pigment composition was analyzed for elemental content (% by weight or ppm) by ICP analysis as shown in Table 1.

TABLE 1

Elemental content
(wt. % or ppm as noted)

| Element | Ex. 1A | Ex. 1B | Ex. 1C | Ex. 2 |
|---|---|---|---|---|
| Al | 2.9 | 3.3 | 2.9 | 1.3 |
| Ca | 3.4 | 3.2 | 4.4 | 475 ppm |
| Fe | 0.637 | 0.186 | 2.09 | 0.480 |
| Si | 0.82 | 2.4 | 5.2 | 4.4 |
| Ti | 30.2 | 26.8 | 24.1 | 32.1 |
| Zn | 0.458 | 0.569 | 0.785 | 510 ppm |

### Example 3

### Coating Compositions

The inorganic pigment compositions from Examples 1 and 2 were evaluated in an architectural interior flat latex paint formulation, SPEEDHIDE® Flat Interior Latex 6-70, which is commercially available from PPG Industries, Inc. The commercial product was used as the control. Test samples were prepared by reducing the TiO₂ in the commercial product by 20 wt. % and replacing it with the pigment compositions of Examples 1 and 2 at a level equivalent to 20, 30, and 40 wt. % of the original loading of TiO₂

Gloss panels were prepared using a 3 mil bird bar on Leneta form 1B (Leneta Company). The panels were allowed to air dry for 30 minutes at room temperature followed by a 20 minute bake in a 120° F. oven. Gloss measurements were taken on a Byk-Gardner micro tri glossmeter at 60° and 85°. The 60° and 85° gloss values of the coatings incorporating inorganic pigment compositions from Examples 1 and 2 were essentially unchanged from the gloss values of the control.

Samples were prepared to test tinting strength by weighing in a one-half pint can an amount of paint equivalent to 25 times the weight per gallon of the paint. The lid was secured and the inside of the can and lid was wetted out with the paint. A set amount of a standard lot of raw umber tint was added to each of the paints. The paints were shaken for 5 minutes to incorporate the tint. Panels were then prepared for tinting strength using a 3 mil bird bar (Byk-Gardner) on 100# NW paper from Colwell General. The panels were allowed to air dry for 30 minutes at room temperature followed by a 20 minute bake in a 120° F. oven. Color measurements were taken on a DATACOLOR® 600 spectrophotometer and compared to the lab made control. The % tinting strength was determined as a ratio of the K/S of the sample (ratio of absorbance to scattering coefficients, according to the Kubelka-Munk equation) to the K/S of the control. The tinting strength for the test samples incorporating the inorganic pigment compositions from Examples 1 and 2 approached or exceeded the tinting strength of the control as the amount of inorganic pigment composition added to the paint was increased, thereby demonstrating that the inorganic pigment composition can be used to replace at least some TiO₂ in a coating composition. In all test samples, the total amount of TiO₂ was less than the amount of TiO₂ in the commercial control sample.

While the preferred embodiments of the present invention are described above, obvious modifications and alterations of the present invention may be made without departing from the spirit and scope of the present invention. The scope of the present invention is defined in the appended claims and equivalents thereto.

What is claimed:

1. A method of recovering inorganic pigment from a coating composition comprising a liquid, an organic component and an inorganic component, the method comprising thermally treating the coating composition to remove at least a portion of the organic component to yield an inorganic pigment composition having a higher concentration of the inorganic pigment than in the coating composition.

2. The method of claim 1, wherein the thermal treatment step comprises heating the composition to a temperature over a period of time whereby the organic component is removed and the inorganic component is unaffected by the thermal treatment.

3. The method of claim 2, wherein the thermal treatment step comprises incinerating the coating composition.

4. The method of claim 2, wherein the inorganic pigment comprises TiO₂.

5. The method of claim 4, wherein the inorganic pigment further comprises a chromatic pigment and the method further comprises removing the chromatic pigment from the coating composition.

6. The method of claim 5, wherein the chromatic pigment is removed before and/or after the thermal treatment step.

7. The method of claim 5, wherein the chromatic pigment is removed by acid extraction.

8. The method of claim 7, wherein the acid extraction step comprises treating the chromatic pigment with HCl.

9. The method of claim 5, wherein the chromatic pigment is removed by magnetic separation.

10. The method of claim 5, wherein the chromatic pigment is removed by centrifuging the coating composition and separating a layer containing the chromatic pigment from a remainder of the coating composition.

11. The method of claim 1, further comprising treating the inorganic pigment composition by milling and/or dispersing in a dispersing medium.

12. The method of claim 1, wherein the inorganic pigment composition comprises 20-65 wt. % TiO₂.

13. The method of claim 1, further comprising, prior to the thermal treatment step, concentrating the coating composition by removing at least a portion of the liquid.

14. The method of claim 13, wherein the concentrating step comprises drying the coating composition.

15. The method of claim 14, wherein the coating composition is dried on a drum dryer.

16. An inorganic pigment composition comprising TiO₂ produced according to the method of claim 1.

17. A coating composition comprising a resinous binder and an inorganic pigment composition comprising TiO₂ produced according to the method of claim 1.

18. The coating composition of claim 17, further comprising TiO₂ from another source.

19. A method of reusing TiO₂ from unused paint samples comprising TiO₂, the method comprising:
removing liquid from a composite of unused paint samples to yield a composite paint concentrate comprising an organic component and an inorganic component comprising TiO₂;
thermally treating the composite paint concentrate to remove at least a portion of the organic component to yield an inorganic composite having a higher concentration of TiO₂ than in the composite of unused paint samples; and
incorporating the inorganic composite into a new paint composition.

20. The method of claim 19, further comprising:
segregating a plurality of unused paint samples according to color to obtain a group of colored paint samples; and
combining the group of colored paint samples together to yield a composite of unused paint samples.

21. The method of claim 19, further comprising removing magnetic materials from the paint samples.

22. The method of claim 19, further comprising adding TiO₂ from another source into the new paint composition.
